(19) United States
(12) Patent Application Publication
(10) Pub. No.: US 2021/0187957 A1
(43) Pub. Date: Jun. 24, 2021

(54) FLUID EJECTION ASSEMBLIES

(71) Applicant: Hewlett-Packard Development Company, L.P., Spring, TX (US)

(72) Inventors: Si-lam Choy, Corvallis, OR (US); Michael W. Cumbie, Corvallis, OR (US)

(73) Assignee: Hewlett-Packard Development Company, L.P., Spring, TX (US)

(21) Appl. No.: 16/758,061

(22) PCT Filed: Nov. 2, 2017
(86) PCT No.: PCT/US2017/059748

§ 371 Date: Apr. 22, 2020

(51) Int. Cl. B41J 2/175; B41J 2/14

(52) U.S. Cl. CPC B41J 2/17513; B41J 2002/14419; B41J 2/17553; B41J 2/14

(57) ABSTRACT

A fluid ejection assembly includes a fluid ejection die, and a body supporting the fluid ejection die, with the body having a fluid chamber communicated with the fluid ejection die and including a receptacle to receive a removable fluid supply, with the receptacle having a fluid port communicated with the fluid chamber through the body.

### BACKGROUND

A fluid ejection die, such as a printhead die in an inkjet printing system, may use thermal resistors or piezoelectric material membranes as actuators within fluidic chambers to eject fluid drops (e.g., ink) from nozzles, such that properly sequenced ejection of ink drops from the nozzles causes characters or other images to be printed on a print medium as the printhead die and the print medium move relative to each other.

### BRIEF DESCRIPTION OF THE DRAWINGS

FIG. 1 is a schematic view illustrating an example of a fluid ejection device.

FIG. 2 is a block diagram illustrating an example of an inkjet printing system including an example of a fluid ejection device.

FIG. 3 is a bottom perspective view illustrating an example of a fluid ejection device.

FIG. 4 is a top perspective view illustrating an example of the fluid ejection device of FIG. 3 including an example of a fluid ejection assembly and an example of a removable fluid supply for the fluid ejection assembly.

FIG. 5 is an exploded perspective view illustrating an example of the fluid ejection device of FIG. 4.

FIG. 6 is an exploded perspective view illustrating an example of the removable fluid supply of FIGS. 4 and 5.

FIGS. 7a, 7b are cross-sectional views illustrating an example of the fluid ejection device of FIG. 4 including an example of the removable fluid supply in an uncompressed state and a compressed state, respectively.

FIG. 8 is a flow diagram illustrating an example of a method of supplying fluid for a fluid ejection assembly.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

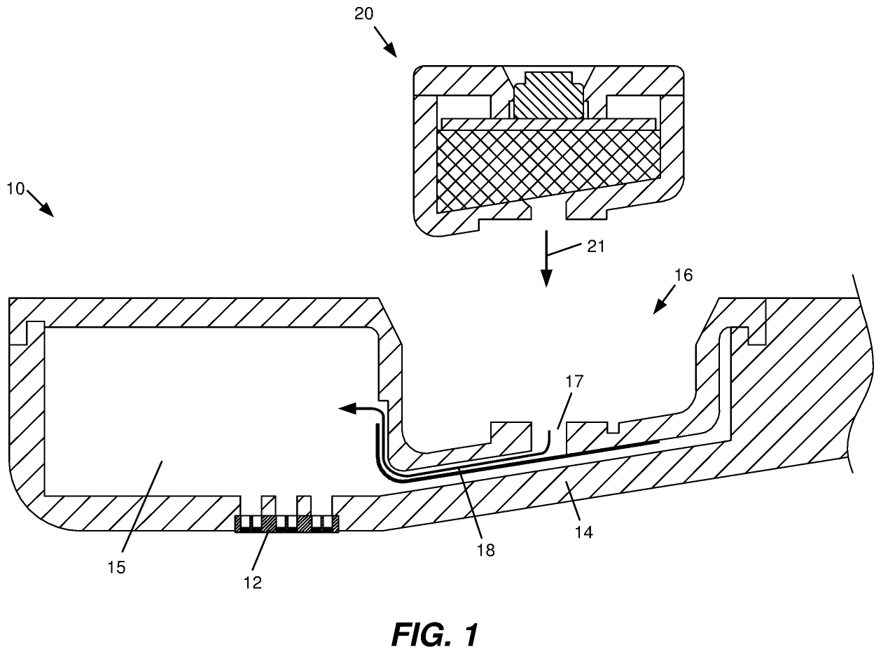

As illustrated in the example of FIG. 1, the present disclosure provides a fluid ejection assembly 10. In one implementation, fluid ejection assembly 10 includes a fluid ejection die 12, and a body 14 supporting fluid ejection die 12, with body 14 having a fluid chamber 15 communicated with fluid ejection die 12 and including a receptacle 16 to receive a removable fluid supply 20, as represented by arrow 21, with receptacle 16 having a fluid port 17 communicated with fluid chamber 15 through body 14, as represented by arrow 18.

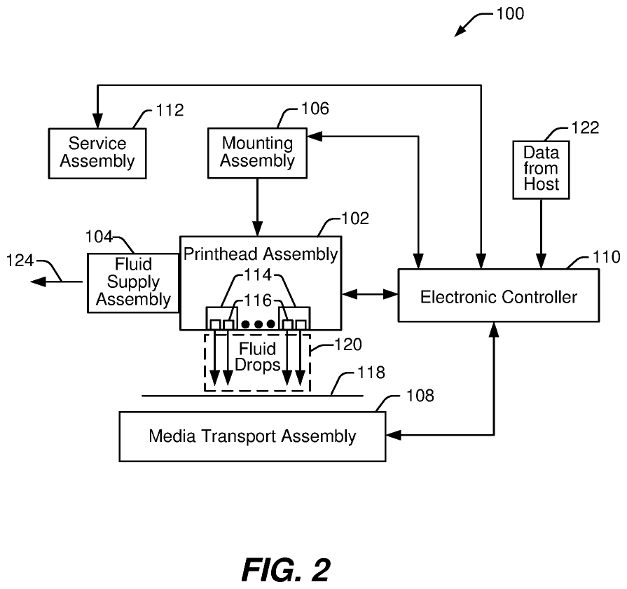

FIG. 2 illustrates an example of an inkjet printing system 100 including an example of a fluid ejection device, as disclosed herein. Inkjet printing system 100 includes a printhead assembly 102, as an example of a fluid ejection assembly, a fluid (ink) supply assembly 104, a mounting assembly 106, a media transport assembly 108, an electronic controller 110, and a service assembly 112.

Printhead assembly 102 includes at least one printhead die 114, as an example of a fluid ejection die, that ejects drops of fluid (ink) through a plurality of orifices or nozzles 116 toward a print medium 118 so as to print on print media 118. Nozzles 116 are typically arranged in one or more columns or arrays such that properly sequenced ejection of fluid (ink) from nozzles 116 causes characters, symbols, and/or other graphics or images to be printed on print media 118 as printhead assembly 102 and print media 118 are moved relative to each other. Print media 118 can be any type of suitable sheet or roll material, such as paper, card stock, transparencies, Mylar, and the like, and may include rigid or semi-rigid material, such as cardboard or other panels.

Fluid (ink) supply assembly 104 supplies fluid (ink) to printhead assembly 102 such that fluid flows from fluid (ink) supply assembly 104 to printhead assembly 102. In one example, fluid (ink) supply assembly 104 is supported by printhead assembly 102 and is removable from printhead assembly 102, as represented, for example, by arrow 124, such that fluid (ink) supply assembly 104 may be replaced.

Mounting assembly 106 positions printhead assembly 102 relative to media transport assembly 108, and media transport assembly 108 positions print media 118 relative to printhead assembly 102. Thus, a print zone 120 is defined adjacent to nozzles 116 in an area between printhead assembly 102 and print media 118. In one example, printhead assembly 102 is a scanning type printhead assembly. As such, mounting assembly 106 includes a carriage for moving printhead assembly 102 relative to media transport assembly 108 to scan print media 118. In another example, printhead assembly 102 is a non-scanning type printhead assembly. As such, mounting assembly 106 fixes printhead assembly 102 at a prescribed position relative to media transport assembly 108.

Electronic controller 110 typically includes a processor, firmware, software, one or more memory components including volatile and non-volatile memory components, and other printer electronics for communicating with and controlling printhead assembly 102, mounting assembly 106, media transport assembly 108, and service assembly 112. Electronic controller 110 receives data 122 from a host system, such as a computer, and temporarily stores data 122 in a memory. Data 122 may be received via an electronic, infrared, optical, or other information transfer path. Data 122 represents, for example, a document and/or file to be printed. As such, data 122 forms a print job for inkjet printing system 100 and includes one or more print job commands and/or command parameters.

In one example, electronic controller 110 controls printhead assembly 102 for ejection of fluid (ink) drops from nozzles 116. Thus, electronic controller 110 defines a pattern of ejected fluid (ink) drops which form characters, symbols, and/or other graphics or images on print media 118. The pattern of ejected fluid (ink) drops is determined by the print job commands and/or command parameters.

Service assembly 112 provides for wiping, capping, spitting, and/or priming of printhead assembly 102 in order to maintain a functionality of printhead assembly 102, including, more specifically, nozzles 116 of printhead die 114. For example, service assembly 112 may include a rubber blade or wiper which periodically contacts and passes over printhead assembly 102 to wipe and clean nozzles 116 of excess ink. In addition, service assembly 112 may include a cap which covers printhead assembly 102 to protect nozzles 116 from drying out during periods of non-use. In addition, service assembly 112 may include a spittoon or absorbent material into which printhead assembly 102 ejects (i.e., spits or purges) ink to insure that fluid (ink) supply assembly 104 maintains an appropriate level of pressure and fluidity, and insure that nozzles 116 do not clog or weep. Functions of service assembly 112 may include relative motion between service assembly 112 and printhead assembly 102.

Printhead assembly 102 includes one (i.e., a single) printhead die 114 or more than one (i.e., multiple) printhead die 114. In one example, printhead assembly 102 is a wide-array or multi-head printhead assembly. In one implementation of a wide-array assembly, printhead assembly 102 includes a carrier that carries a plurality of printhead dies 114, provides electrical communication between printhead dies 114 and electronic controller 110, and provides fluidic communication between printhead dies 114 and fluid (ink) supply assembly 104.

In one example, inkjet printing system 100 is a drop-on-demand thermal inkjet printing system wherein printhead assembly 102 includes a thermal inkjet (TIJ) printhead that implements a thermal resistor as a drop ejecting element to vaporize fluid (ink) in a fluid chamber and create bubbles that force fluid (ink) drops out of nozzles 116. In another example, inkjet printing system 100 is a drop-on-demand piezoelectric inkjet printing system wherein printhead assembly 102 includes a piezoelectric inkjet (PIJ) printhead that implements a piezoelectric actuator as a drop ejecting element to generate pressure pulses that force fluid (ink) drops out of nozzles 116.

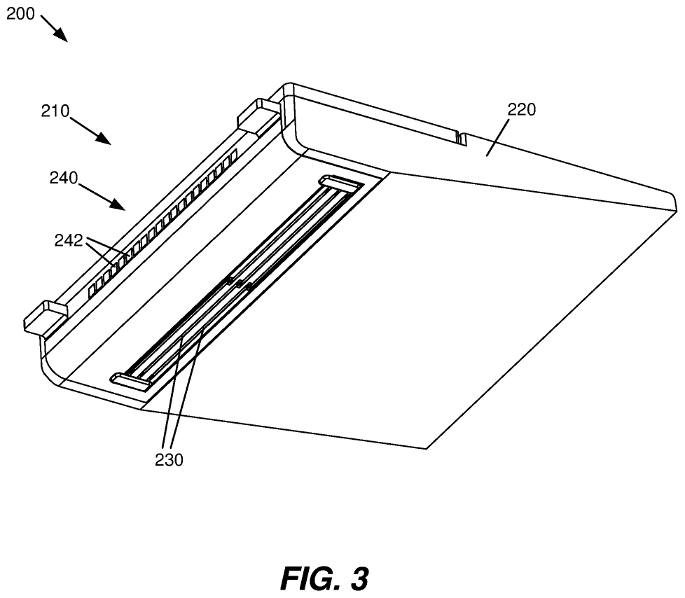

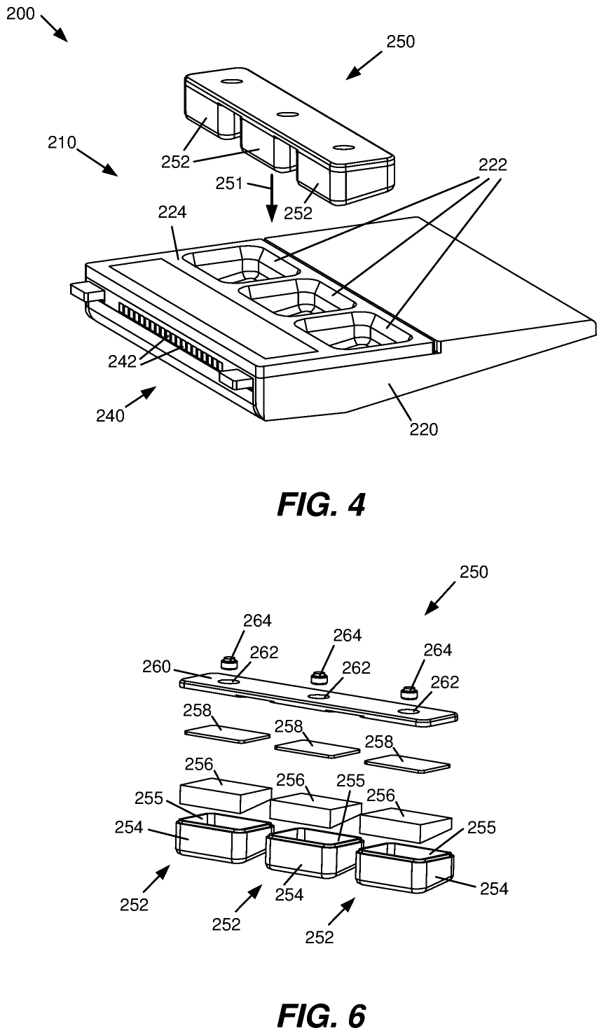

FIGS. 3 and 4 are bottom and top perspective views, respectively, illustrating an example of a fluid ejection device 200 in accordance with the present disclosure. In the illustrated example, fluid ejection device 200 includes a fluid ejection assembly 210, as an example of printhead assembly 102 (FIG. 2), and a fluid supply 250, as an example of fluid (ink) supply assembly 104 (FIG. 2). As disclosed herein, fluid supply 250 is support by and removable from fluid ejection assembly 210.

In one example, fluid ejection assembly 210 includes a housing or body 220, a fluid ejection die 230, and an electrical circuit 240 such that fluid ejection die 230 is supported by body 220 and electrically coupled with electrical circuit 240. In one implementation, fluid ejection die 230, as an example of printhead die 114 (FIG. 2), includes a drop-on-demand thermal inkjet (TIJ) printhead, as described above. In another implementation, fluid ejection die 230, as an example of printhead die 114 (FIG. 2), includes a drop-on-demand piezoelectric inkjet (PIJ) printhead, as described above. In either example, fluid ejection die 230 includes orifices or nozzles, such as orifices or nozzles 116 (FIG. 2), through which drops of fluid (ink) are ejected, as described above. In one example, fluid ejection die 230 includes a thin-film structure formed on a substrate with the substrate formed, for example, of silicon, glass, or a stable polymer, and the thin-film structure including conductive, passivation or insulation layers.

In one example, body 220 supports fluid ejection die 230 and electrical circuit 240 such that electrical circuit 240 facilitates communication of electrical signals between an electronic controller, such as electronic controller 110 (FIG. 2), and fluid ejection die 230 for controlling and/or monitoring operation of fluid ejection die 230.

In one example, electrical circuit 240 includes a plurality of electrical contacts 242 and a plurality of conductive paths which extend between and provide electrical connection between electrical contacts 242 and fluid ejection die 230. Electrical contacts 242 provide points for electrical connection to fluid ejection assembly 210 and, more specifically, fluid ejection die 230. As such, electrical contacts 242 facilitate communication of power, ground, and/or data signals with fluid ejection die 230. In one implementation, electrical circuit 240 is supported by body 220 such that electrical contacts 242 are provided at end of body 220.

In one example, electrical circuit 240 is a flexible electrical circuit with conductive paths formed in or on a flexible base material. The flexible base material may include, for example, a polyimide or other flexible polymer material (e.g., polyester, poly-methyl-methacrylate), and the conductive paths may be formed of copper, gold, or other conductive material.

In one implementation, fluid ejection assembly 210 includes multiple fluid ejection die 230 supported by body 220 such that fluid ejection assembly 210 provides a wide-array (e.g., page-wide array) printhead assembly. As a wide-array or multi-head printhead assembly, the multiple fluid ejection die 230 of fluid ejection assembly 210 are arranged and aligned in one or more staggered or overlapping rows such that a fluid ejection die 230 in one row overlaps at least one fluid ejection die 230 in another row. As such, fluid ejection assembly 210 may span a nominal page width or a width shorter or longer than a nominal page width.

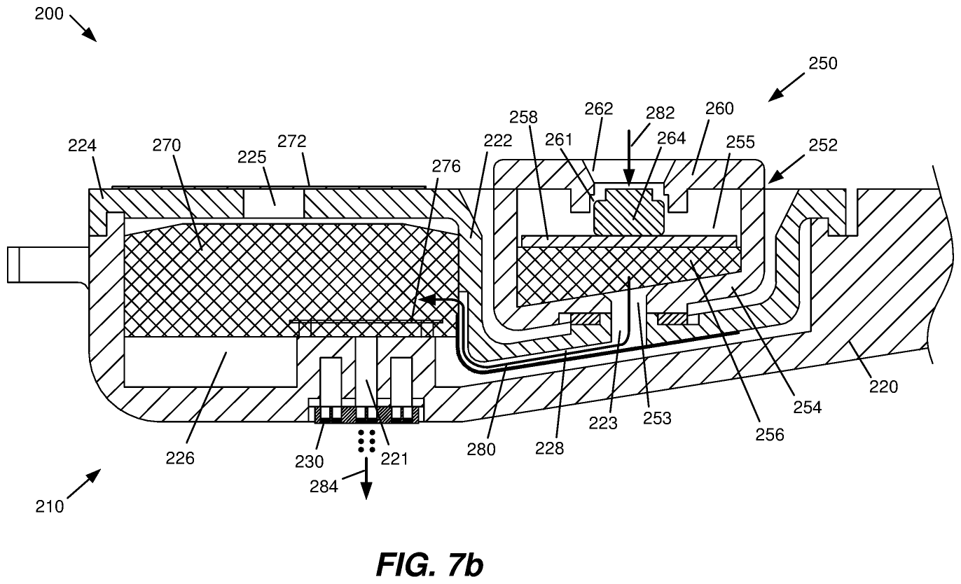

In one example, body 220 supports fluid supply 250 such that fluid supply 250 communicates with and supplies fluid (ink) to fluid ejection die 230. More specifically, in one example, body 220 of fluid ejection assembly 210 includes a tub or receptacle 222 for receiving and supporting fluid supply 250. In one implementation, body 220 includes a lid or cover 224 with tub or receptacle 222 being formed or provided in cover 224. In one example, cover 224 is provided on a side of body 220 opposite of fluid ejection die 230 and receptacle 222 is open in a direction opposite a direction of ejection of drops of fluid from fluid ejection die 230 (see, for example, FIGS. 1, 7b). As such, fluid supply 250 is inserted into receptacle 222 in a direction substantially perpendicular to cover 224, as represented by arrow 251. Accordingly, fluid supply 250 is inserted into receptacle 222 in a direction the same as a direction of ejection of drops of fluid from fluid ejection die 230 (see, for example, FIG. 7b).

In one implementation, as illustrated in the example of FIG. 4, fluid supply 250 includes a plurality of fluid supply pods or blisters 252 and fluid ejection assembly 210 includes a plurality of receptacles 222 for separately receiving and supporting individual fluid supply pods or blisters 252.

In one example, fluid supply pods or blisters 252 of fluid supply 250 may include different types or colors of fluid. As such, fluid ejection die 230 may be supplied with more than one type or color of fluid (e.g., fluids of different dyes, pigments, constituents, substances, agents, reactants, reagents, or colors) and may include a column (or columns) of orifices or nozzles for each type or color of fluid. In some examples, fluid supply pods or blisters 252 of fluid supply 250 may include different colors of fluid such that fluid ejection die 230 may eject different colors of fluid (e.g., cyan, magenta, yellow, and black ink). In other examples, fluid supply pods or blisters 252 of fluid supply 250 may include different types of fluid such that fluid ejection die 230 may eject at least two types of fluid. For example, fluid ejection die 230 may correspond to a lab-on-a-chip device, where a first fluid may be a reagent, and a second fluid may be a solution including test material therein.

Although illustrated as including three fluid supply pods or blisters 252, fluid supply 250 may include any number of fluid supply pods or blisters 252 (for example one, two, three, or more).

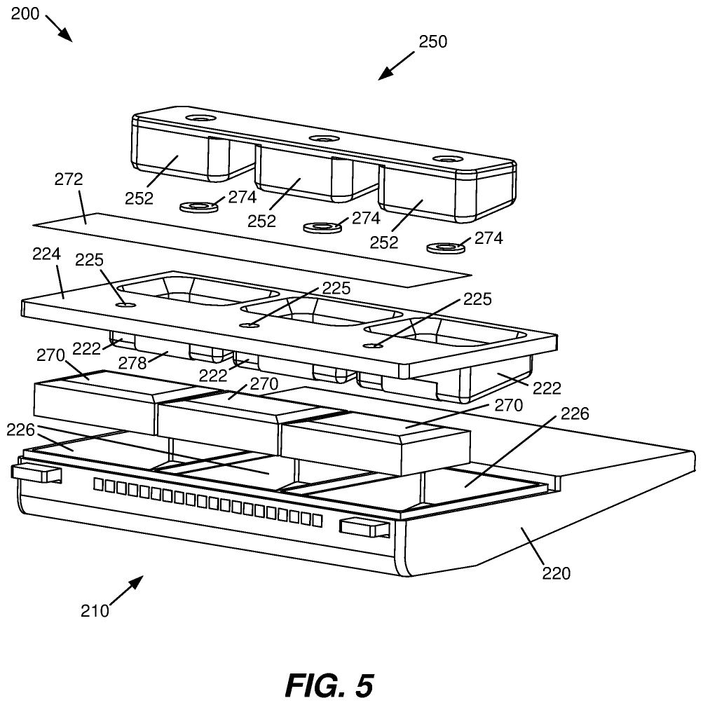

FIG. 5 is an exploded perspective view illustrating an example of fluid ejection device 200. In the illustrated example, body 220 of fluid ejection assembly 210 includes a fluid cavity or fluid chamber 226 fluidically communicated with fluid ejection die 230 (see, for example, FIGS. 7a, 7b) such that cover 224 of body 220 fits over and seals fluid chamber 226. In one implementation, fluid chamber 226 includes a plurality of fluid chambers 226 with tubs or receptacles 222 of cover 224 extending into and fitting within a respective fluid chamber 226.

In one implementation, an absorbent material 270 (e.g., foam material) is positioned within each fluid chamber 226 to provide back pressure to fluid ejection die 230 during ejection of fluid therefrom. In addition, in one implementation, a vent 225 corresponding to each fluid chamber 226 is provided in cover 224. As such, vent 225 allows air to pass into and out of fluid chamber 226. In one example, a permeable seal 272 (e.g., permeable tape) is provided over vents 225 such that air is allowed to pass through permeable seal 272 while fluid is prevented from passing through permeable seal 272. In one example, vents 225 include a labyrinth or serpentine structure or channel to increase the length of and thereby slow the rate of evaporation through vents 225. In one implementation, the labyrinth or serpentine structure or channel is formed in a top surface of cover 224 such that an end of the labyrinth or serpentine structure or channel extends past an edge of permeable seal 272.

In one example, a fluid interconnect seal 274 (e.g., O-ring) is provided to provide a fluid-tight seal between fluid supply pods or blisters 252 of fluid supply 250 and tubs or receptacles 222 of cover 224 of body 220.

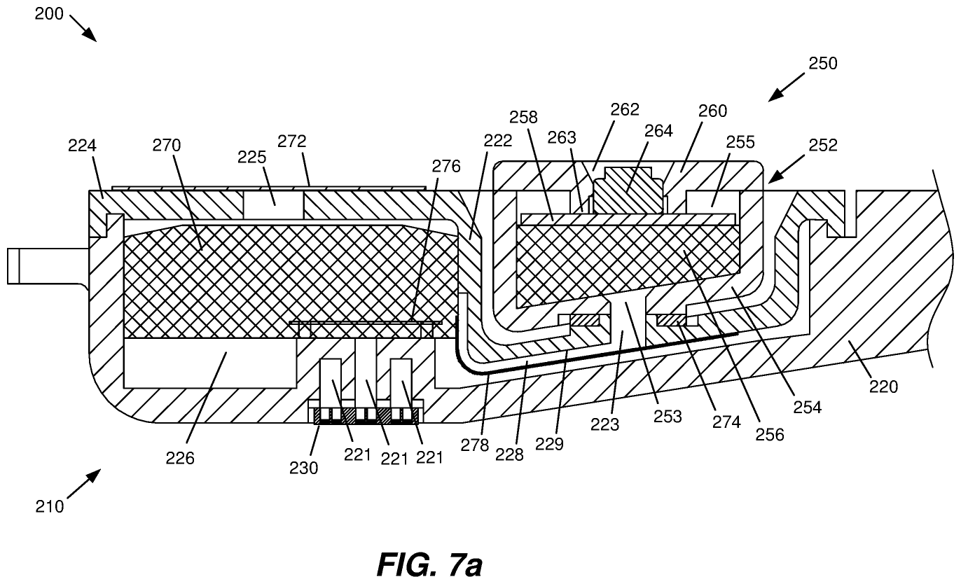

FIG. 6 is an exploded perspective view illustrating an example of fluid supply 250. In the illustrated example, each fluid supply pod or blister 252 includes a container or housing 254 forming a fluid reservoir 255, a compressible member 256 (e.g., foam material) disposed within fluid reservoir 255 in housing 254, and a rigid member or press plate 258 disposed within fluid reservoir 255 in housing 254. In one implementation, press plate 258 is in contact with compressible member 256 and is moved or pressed against compressible member 256 to compress compressible member 256 and force fluid from fluid reservoir 255 of fluid supply pod or blister 252, as described below.

In one example, fluid supply 250 includes a cap or lid 260. In one implementation, lid 260 is common to multiple fluid supply pods or blisters 252. In other implementations, each fluid supply pod or blister 252 includes an individual lid 260. In one example, lid 260 includes a port 262 corresponding to each fluid supply pod or blister 252.

In one example, each fluid supply pod or blister 252 includes a plunger seal 264 slidingly fit in a respective port 262. As such, plunger seal 264 seals a respective port 262 and is depressed or pressed inward to press against and move press plate 258 to compress compressible member 256, as described below.

FIGS. 7a, 7b are cross-sectional views illustrating an example of fluid ejection device 200 including an example of fluid ejection assembly 210 and an example of fluid supply 250 with fluid supply 250 in an uncompressed state and a compressed state, respectively. As illustrated in the example of FIGS. 7a, 7b, absorbent material 270 is positioned within fluid chamber 226 of body 220, and cover 224 is secured to body 220. As such, vent 225 communicates with fluid chamber 226 and permeable seal 272 covers vent 225 such that air is allowed to pass through vent 225 to and from fluid chamber 226.

As described below, fluid chamber 226 is supplied with fluid from fluid supply 250 such that fluid within fluid chamber 226 is communicated with fluid ejection die 230 as supported by body 220. In one example, body 220 has one or multiple fluid passages 221 formed therein which communicate with fluid chamber 226 and fluid ejection die 230 such that fluid from fluid chamber 226 is communicated with fluid ejection die 230 through body 220. In one example, each fluid passage 221 communicates with a different fluid chamber 226 such that fluid from a respective fluid chamber 226 is communicated with fluid ejection die 230. In one implementation, a filter 276 is provided within a fluid path between fluid chamber 226 and fluid passage or passages 221 to filter fluid supplied to fluid ejection die 230 through fluid passage or passages 221.

As illustrated in the example of FIG. 7a, fluid supply 250 including, more specifically, fluid supply pod or blister 252 (with fluid therein) is inserted into or positioned within tub or receptacle 222 of body 220. In one example, when fluid supply pod or blister 252 is inserted into or positioned within tub or receptacle 222, a fluid port 253 of housing 254 communicates with a fluid port 223 of tub or receptacle 222 to form a fluid interconnect between fluid supply 250, namely, fluid reservoir 255 of fluid supply 250, and body 220, namely, tub or receptacle 222 of body 220. In one implementation, fluid interconnect seal 274 is positioned between fluid supply pod or blister 252 and tub or receptacle 222 to provide a fluid-tight seal between fluid supply pod or blister 252 and tub or receptacle 222.

In one example, cover 224 of body 220 includes a fluid path 228 communicated between fluid port 223 and fluid chamber 226 such that fluid from fluid supply 250 is supplied to fluid chamber 226 through fluid port 253, fluid port 223, and fluid path 228. In one implementation, fluid path 228 is formed by a groove or fluid channel 229 in cover 224, namely, in a portion of cover 224 forming tub or receptacle 222, and a fluid routing film 278 (see also FIG. 5) secured to cover 224 over fluid channel 229 such that one end of fluid channel 229 is communicated with fluid port 223 and an opposite end of fluid channel 229 is open to fluid chamber 226.

As illustrated in the example of FIG. 7a, fluid supply 250 is in an uncompressed state, with compressible member 256 positioned within fluid reservoir 255 of housing 254, press plate 258 in contact with compressible member 256, and plunger seal 264 fit within port 262 of lid 260. In the uncompressed state, plunger seal 264 is positioned within port 262 of lid 260 such that compressible member 256 pushes press plate 258 toward or against plunger seal 264 and a lip 263 of port 262.

As illustrated in the example of FIG. 7b, fluid supply 250 is in a compressed state. In the compressed state, plunger seal 264 is depressed or pressed into housing 254 relative to lid 260 such that press plate 258 is moved and pressed against compressible member 256 whereby compressible member 256 is compressed. In one example, when plunger seal 264 is depressed, a vent 261 within port 262 is opened such that air may pass into and out of fluid supply 250. In one example, plunger seal 264 is depressed or pressed into housing 254 by a pin or projection provided, for example, on a latch or case closure (not shown) for fluid ejection assembly 210.

As illustrated in the example of FIG. 7b, when compressible member 256 is compressed, fluid from fluid supply 250, namely, fluid from fluid reservoir 255 of fluid supply 250, is forced through fluid port 253, fluid port 223, and fluid path 228 to fluid chamber 226, as represented by arrow 280. As such, fluid within fluid chamber 226 is supplied to fluid ejection die 230 (e.g., through filter 276 and fluid passage 221) for ejection from fluid ejection die 230.

In one example, as illustrated in FIG. 7b, to compress compressible member 256 and force fluid to fluid chamber 226, plunger seal 264 is depressed in a direction indicated by arrow 282. In addition, during operation of fluid ejection device 200, drops of fluid are ejected from fluid ejection die 230 in a direction indicated by arrow 284. As such, plunger seal 264 is depressed in a direction the same as a direction of ejection of drops of fluid from fluid ejection die 230 (e.g., downward in the illustrated example).

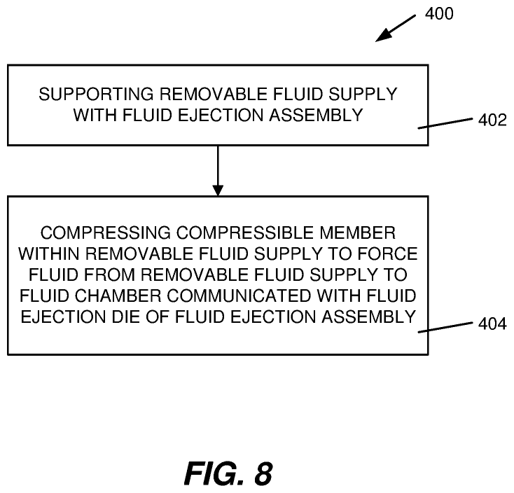

FIG. 8 is a flow diagram illustrating an example of a method 400 of supplying fluid for a fluid ejection assembly, such as fluid ejection assembly 210 of fluid ejection device 200 as illustrated, for example, in FIGS. 3, 4, 5. At 402, method 400 includes supporting a removable fluid supply with the fluid ejection assembly, such as supporting removable fluid supply 250 with fluid ejection assembly 210, as illustrated, for example, in FIGS. 4, 5, 7a, 7b. And, at 404, method 400 includes compressing a compressible member within the removable fluid supply to force fluid from the removable fluid supply to a fluid chamber communicated with a fluid ejection die of the fluid ejection assembly, such as compressing compressible member 256 within removable fluid supply 250 to force fluid from removable fluid supply 250 to fluid chamber 226 communicated with fluid ejection die 230 of fluid ejection assembly 210, as illustrated, for example, in FIG. 7b.

In one example, supporting the removable fluid supply, at 402, includes removably supporting removable fluid supply 250 within receptacle 222 of fluid ejection assembly 210 and fluidically communicating removable fluid supply 250 with fluid port 223 of receptacle 222, as illustrated, for example, in FIG. 7a.

In one example, compressing the compressible member, at 404, includes pressing plunger seal 264 of removable fluid supply 250 against press plate 258 within removable fluid supply 250 and pressing press plate 258 against compressible member 256, as illustrated, for example, in FIG. 7b.

By removably supporting fluid supply 250 on fluid ejection assembly 210, as disclosed herein, an integrated fluid ejection device 200 with a replaceable fluid supply and compact or reduced form factor may be achieved. As such, fluid ejection device 200, as disclosed herein, may be implemented, for example, in a pocket-sized printer.

Example fluid ejection devices, as described herein, may be implemented in printing devices, such as two-dimensional printers and/or three-dimensional printers (3D). As will be appreciated, some example fluid ejection devices may be printheads. In some examples, a fluid ejection device may be implemented into a printing device and may be utilized to print content onto a media, such as paper, a layer of powder-based build material, reactive devices (such as lab-on-a-chip devices), etc. Example fluid ejection devices include ink-based ejection devices, digital titration devices, 3D printing devices, pharmaceutical dispensation devices, lab-on-chip devices, fluidic diagnostic circuits, and/or other such devices in which amounts of fluids may be dispensed/ejected.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein.

1. A fluid ejection assembly, comprising:
a fluid ejection die; and
a body supporting the fluid ejection die, the body having a fluid chamber communicated with the fluid ejection die and including a receptacle to receive a removable fluid supply, the receptacle having a fluid port communicated with the fluid chamber through the body.

2. The fluid ejection assembly of claim 1, the fluid ejection die to eject drops of fluid in a first direction, and the receptacle open in a second direction opposite the first direction.

3. The fluid ejection assembly of claim 2, the receptacle to receive the removable fluid supply in the first direction.

4. The fluid ejection assembly of claim 1, the body having a vent communicated with the fluid chamber.

5. The fluid ejection assembly of claim 1, further comprising:
an absorbent material within the fluid chamber of the body.

6. The fluid ejection assembly of claim 1, the removable fluid supply to include a housing having a compressible member therein, a press plate in contact with the compressible member, and a plunger seal in contact with the press plate, the compressible member to be compressed by the press plate, and the press plate to be pressed against the compressible member by the plunger seal to compress the compressible member and supply fluid to the fluid chamber of the body.

7. The fluid ejection assembly of claim 6, the fluid ejection die to eject drops of fluid in a first direction, and the plunger seal to be depressed in the first direction.

8. A fluid supply, comprising:
a housing forming a fluid reservoir;
a compressible member disposed within the fluid reservoir;
a rigid member disposed within the fluid reservoir in contact with the compressible member;
a lid secured to the housing and having a port formed therethrough; and
a plunger seal slidingly fit in the port,
the plunger seal to be depressed to press the rigid member against the compressible member to force fluid from the fluid reservoir.

9. The fluid supply of claim 8, when depressed, the plunger seal to open an air vent in the port.

10. The fluid supply of claim 8, the housing comprising a plurality of housings each forming a respective fluid reservoir, with a respective compressible member disposed within the respective fluid reservoir and a respective rigid member disposed within the respective fluid reservoir in contact with the respective compressible member,
the lid secured to each of the housings and having a plurality of ports formed therethrough corresponding to each of the housings, and
the plunger seal comprising a plurality of plungers seals each slidingly fit within a respective one of the ports.

11. A method of supplying fluid for a fluid ejection assembly, comprising:
supporting a removable fluid supply with the fluid ejection assembly; and
compressing a compressible member within the removable fluid supply to force fluid from the removable fluid supply to a fluid chamber communicated with a fluid ejection die of the fluid ejection assembly.

12. The method of claim 11, wherein supporting the removable fluid supply includes removably supporting the removable fluid supply within a receptacle of the fluid ejection assembly and fluidically communicating the removable fluid supply with a fluid port of the receptacle.

13. The method of claim 12, wherein compressing the compressible member includes forcing fluid through a fluid path communicated between the fluid port and the fluid chamber.

14. The method of claim 11, wherein compressing the compressible member includes pressing a plunger seal of the removable fluid supply against a press plate within the removable fluid supply and pressing the press plate against the compressible member.

15. The method of claim 14, wherein pressing the plunger seal includes opening an air vent.
